(19) United States
(12) Patent Application Publication
(10) Pub. No.: US 2016/0064819 A1
(43) Pub. Date: Mar. 3, 2016

(54) ARRAY ANTENNA COMPRISING SECTIONS SERIALLY LINKABLE TO CENTRAL NODE IN DIFFERENT SPATIAL CONFIGURATIONS

(71) Applicant: QUALCOMM Incorporated, San Diego, CA (US)

(72) Inventors: Farbod Tabatabai, San Jose, CA (US); Dieter Statezni, Cupertino, CA (US)

(21) Appl. No.: 14/469,377

(22) Filed: Aug. 26, 2014

(51) Int. Cl. H01Q 5/364; H01Q 3/24

(52) U.S. Cl. CPC H01Q 5/364; H01Q 3/242

(57) ABSTRACT

Embodiments relate to an array antenna comprising a plurality of RF sections of equal length serially linkable to a central RF feed point in different spatial configurations. One arrangement has the RF sections in the form of a circular wheel/spoke, with switching elements (e.g., PIN diodes) located at junctions between RF sections. In operation, the switching elements create open/short circuits at select locations so that the antennas are connected serially in different orders. The center antenna is coupled to the input of the RF transceiver for sending and receiving signals. However, because the antenna array is switchable, different antennas in different physical locations around the center antenna may be configured as the terminal antenna. The path from different terminal antennas to the center antenna can be changed to optimize signal reception and throughput. These various spatial configurations offer improved communication throughput for signals (including reflected signals) incoming from different directions.

### BACKGROUND

The disclosure relates to array antenna structures, and in particular, to array antennas comprising sections selectively linkage to a central node in different spatial configurations.

Unless otherwise indicated herein, the approaches described in this section are not admitted to be prior art by inclusion in this section.

In a series-fed phase shift array, the input signal (fed from one end of the feed network) is coupled serially to the antenna elements. The compactness of the feed network of such series-fed array antennas, can offer benefits relative to parallel-fed array antenna designs.

Apart from offering compactness, the small size of series-fed arrays can also result in less insertion and radiation losses by the feed network. In particular the cumulative nature of the phase shift in series phase shift array antennas, relaxes design considerations on the phase tuning range of the phase shift elements.

Specifically, an N-element series-fed phase shift array utilize only (N−1) of phase shift elements. This is in contrast with a parallel-feed antenna array, which calls for N phase shift elements.

Conventional series-fed array antennas may feature individual elements that are fixed in space relative to one another, and fixed in space relative to incoming signals. However such a static configuration of antenna elements may be sub-optimal for receiving incoming wireless signals having wavefronts moving in particular directions (including wavefronts of reflected signals). Moreover, the conventional fixed array antenna configuration may result in phase mis-match between individual antenna array elements that are oriented differently with respect to a direction of an incoming wireless signal.

### SUMMARY

The present disclosure describes an array antenna comprising individual sections that are selectively linkable in series to a central node in different spatial configurations. One particular arrangement has the RF sections in the form of a circular wheel/spoke, with switching elements (e.g., PIN diodes) located at junctions between RF sections. In operation, the switching elements create open/short circuits at select locations so that the antennas of the RF sections are connected serially in different orders. The center antenna is coupled to the input of the RF transceiver for sending and receiving signals. However, because the antenna array is switchable, different antennas in different physical locations around the center node may be configured as the terminal antenna. The path from different terminal antennas to the center antenna can thus be changed to optimize signal reception and communication throughput (e.g., as indicated by metrics such as Packet Error Rate-PER or Received Signal Strength Indicator-RSSI). These various spatial configurations offer improved communication throughput for signals (including reflected signals) incoming from different directions. Also disclosed is a procedure for iterating through various possible serial connections of array antenna sections in order to identify a spatial configuration suited for a particular signal.

An embodiment of an antenna comprises a center antenna located at a central feed point, and conducting sections of equal length disposed around the central feed point, each conducting section coupled to a respective antenna. Switching elements are disposed between the conducting sections. A controller is in communication with the switching elements to serially connect the conducting sections in spatial configurations having different terminal antennas, the controller in communication with the central feed point to determine a signal communication throughput for each spatial configuration.

An embodiment of a method comprises controlling switching elements to define serially connected conducting sections of equal length and associated coupled antennas, in a first spatial configuration between a central feed point and a first terminal antenna. A first signal communication throughput of the first spatial configuration is determined. The switching elements are controlled to define serially connected conducting sections and associated coupled antennas, in a second spatial configuration between the central feed point and a second terminal antenna. A second signal communication throughput of the second spatial configuration is determined.

In certain embodiments the switching elements comprise diodes.

According to some embodiments the diodes comprise PIN diodes.

In particular embodiments the conducting sections comprise a connecting section in communication with the central feed point, and a peripheral section in communication with the connecting section.

According to various embodiments the connecting section defines a spoke and the peripheral section defines a part of a wheel.

In some embodiments the peripheral section defines a part of a polygon.

In certain embodiments the peripheral section has a non-linear shape.

According to particular embodiments the conducting sections comprise strips on a printed circuit board (PCB).

In some embodiments the controller may be configured to determine the signal communication throughput as a Packet Error Rate (PER).

In some embodiments the controller is configured to determine the signal communication throughput as a Received Signal Strength Indicator (RSSI).

Following detailed description and accompanying drawings provide a better understanding of the nature and advantages of the present disclosure.

### BRIEF DESCRIPTION OF THE DRAWINGS

With respect to the discussion to follow and in particular to the drawings, it is stressed that the particulars shown represent examples for purposes of illustrative discussion, and are presented in the cause of providing a description of principles and conceptual aspects of the present disclosure. In this regard, no attempt is made to show implementation details beyond what is needed for a fundamental understanding of the present disclosure. The discussion to follow, in conjunction with the drawings, make apparent to those of skill in the art how embodiments in accordance with the present disclosure may be practiced. In the accompanying drawings:

FIG. 1A is a simplified diagram showing a spatial arrangement of an antenna element resulting in high gain.

FIG. 1B is a simplified diagram showing a spatial arrangement of an antenna element resulting in lower gain.

FIG. 1C illustrates phase difference in a linear array antenna.

FIG. 2 illustrates one embodiment of an array antenna configured in a wheel/spoke shape.

FIG. 2A is an enlarged cross-section of the embodiment of FIG. 2.

FIG. 2B is a simplified view of a process flow according to an embodiment.

FIG. 3A shows serial connection of the antenna elements of the embodiment of FIG. 2 to result in one spatial configuration.

FIG. 3B shows serial connection of the antenna elements of the embodiment of FIG. 2 to result in another spatial configuration.

FIG. 3C shows serial connection of the antenna elements of the embodiment of FIG. 2 to result in another spatial configuration.

FIG. 4 illustrates one embodiment of an antenna array configured in a square shape.

FIG. 5 is a flow diagram illustrating an embodiment of a procedure for optimizing an array antenna according to an embodiment.

FIG. 6 shows an embodiment of a system comprising an array antenna in communication with a controller. FIGS. 6A-B show details of the connections of FIG. 6.

### DETAILED DESCRIPTION

In the following description, for purposes of explanation, numerous examples and specific details are set forth in order to provide a thorough understanding of the present disclosure. It will be evident, however, to one skilled in the art that the present disclosure as expressed in the claims may include some or all of the features in these examples, alone or in combination with other features described below, and may further include modifications and equivalents of the features and concepts described herein.

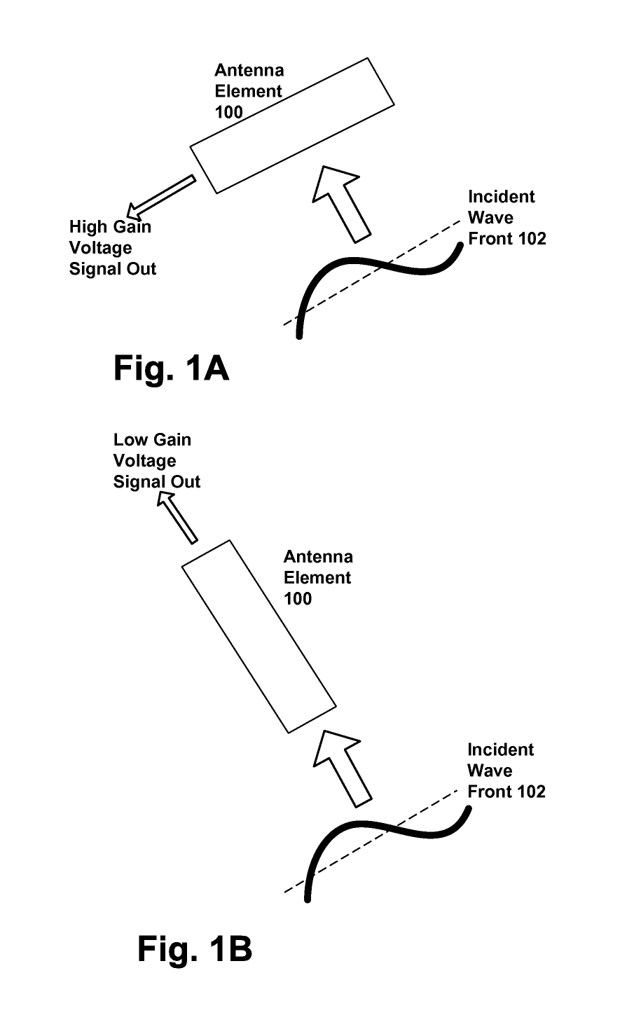

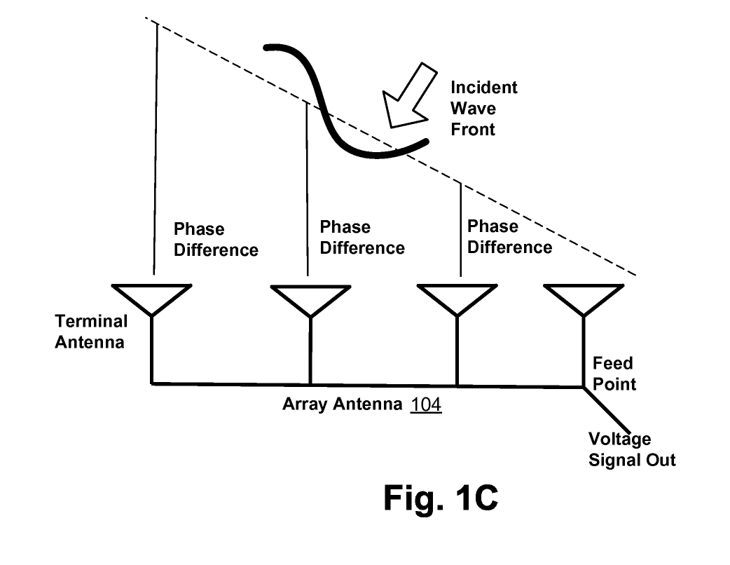

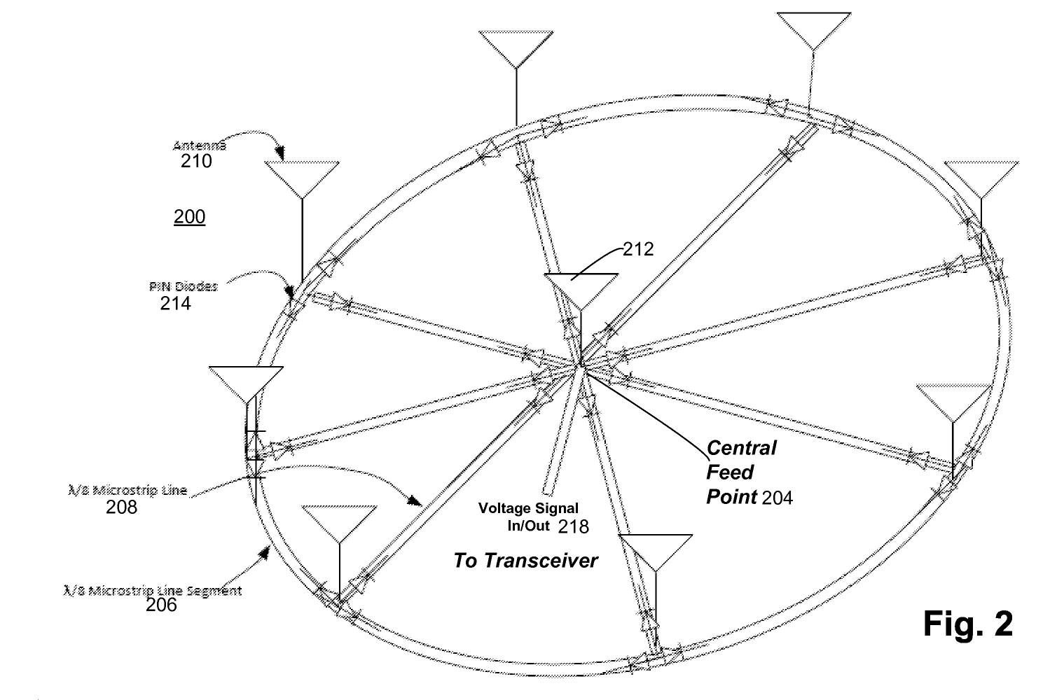

FIGS. 1A-1B are highly simplified views showing the relationship between spatial orientation of an antenna element, and gain of the voltage signal received from an incoming wireless signal. In particular, FIG. 1A shows that higher gain is achieved where the antenna element 100 is oriented substantially parallel (in phase) to a wavefront 102 of an incoming wireless signal. By contrast, FIG. 1B shows that less gain is expected where the antenna element 100 is not oriented substantially parallel (out of phase) to the wavefront 102 of the incoming wireless signal.

It is noted that FIGS. 1A-1B are simplified in that they do not recognize that an incoming wireless signal may come from a plurality of directions. One example of this is where reflections of the incoming signal by nearby objects, are received in addition to the original signal itself.

FIGS. 1A-1B are also simplified in that they show an antenna comprising only a single element, rather than a plurality of elements as in the case of an array antenna. Where such a plurality of elements are in fact present in an array antenna, the gain of the overall signal resulting from the serial-fed elements may represent the complex combination of a multiple signals that differ in phase from one another.

This is illustrated in connection with FIG. 1C, which shows a linear array antenna 104 oriented relative to a wave front of an incoming wireless signal. Owing to the distances between the elements of the array antenna and their orientation in space relative to the incoming wireless signal, phase differences of varying degrees may arise between the terminal antenna of the array, intervening antennas, and the antenna located at the feed node (experiencing zero delay). These phase differences between the voltage signals of the individual elements of the array antenna, can undesirably result in interference effects degrading the gain of the overall signal that is output from the array.

Thus according to embodiments, an array antenna may optimize the gain of an output voltage signal by comprising a plurality of individual sections that are serially linkable to a central feed point in a variety of different spatial configurations.

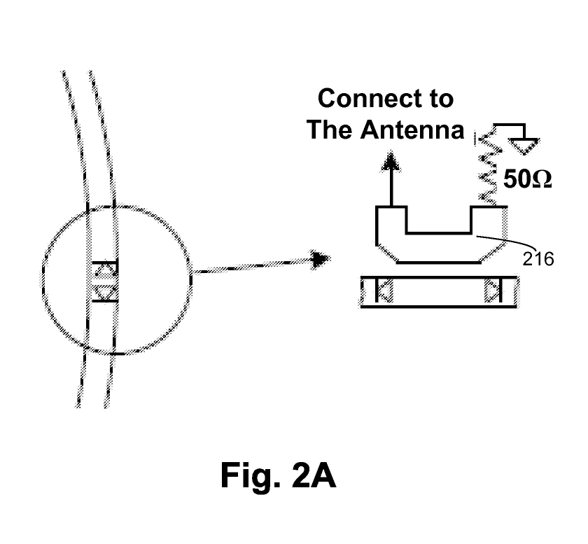

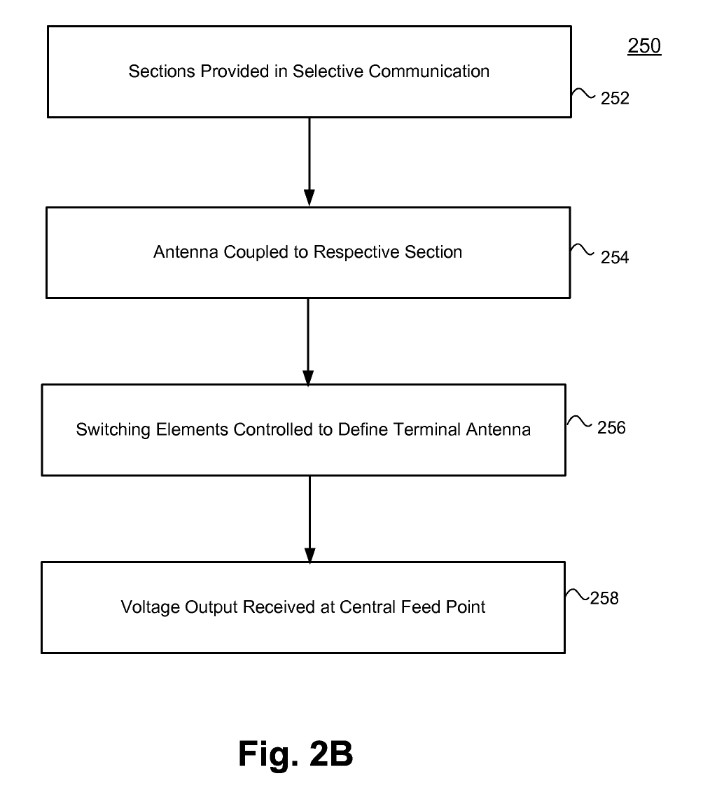

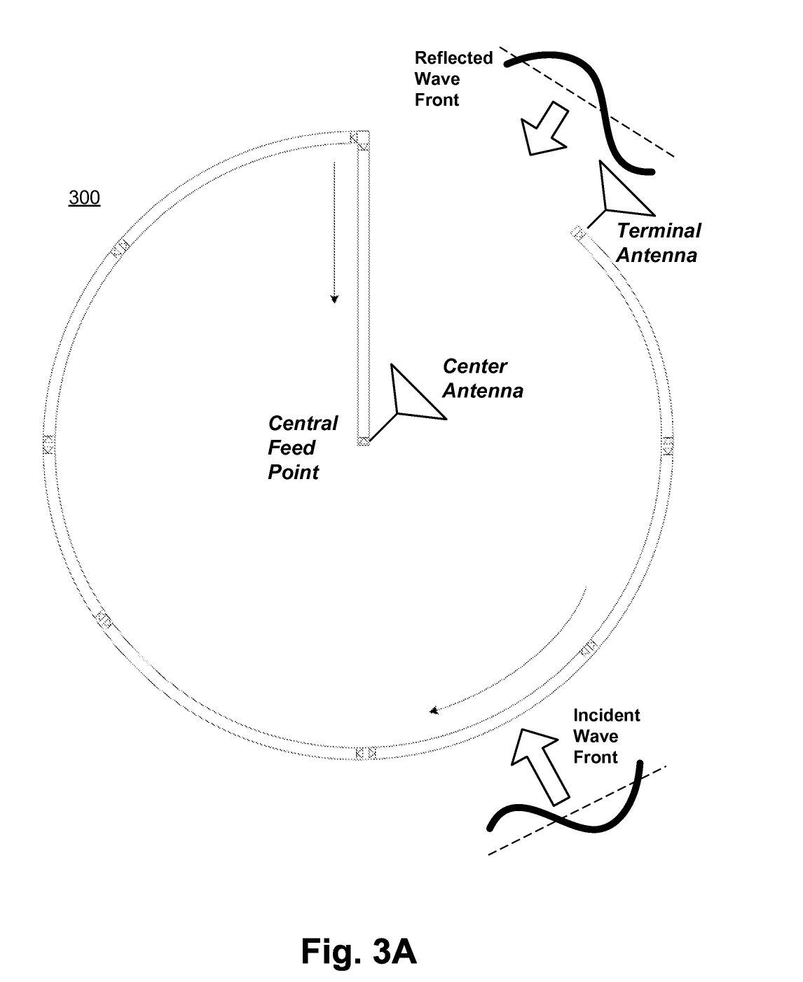

FIG. 2 shows one possible arrangement 200 of a plurality of RF sections 202 in the form of a circular wheel with spokes. In this particular embodiment, the RF sections may be in the form of a conducting microstrip printed on a printed circuit board (PCB).

Here, the specific arrangement of FIG. 2 comprises a total of sixteen (16) sections of the same length, with eight (8) of those sections able to be selectively connected in series with a central feed point 204 in various spatial configurations.

The combined length of the serially-connected sections, corresponds to the expected wavelength (λ) of the incoming signal. Thus here, each of the elements has a length (λ/8). Eight microstrip line segments 206 make up the peripheral sections of the wheel, and eight microstrip lines 208 comprise connecting sections of the spokes.

Each peripheral antenna element 210 on the wheel portion of the array is located within λ/8 with respect to adjacent antennas also on the wheel. These antenna feeders on the periphery are placed within λ/8 of the center antenna 212 that is located at the center feed point 204.

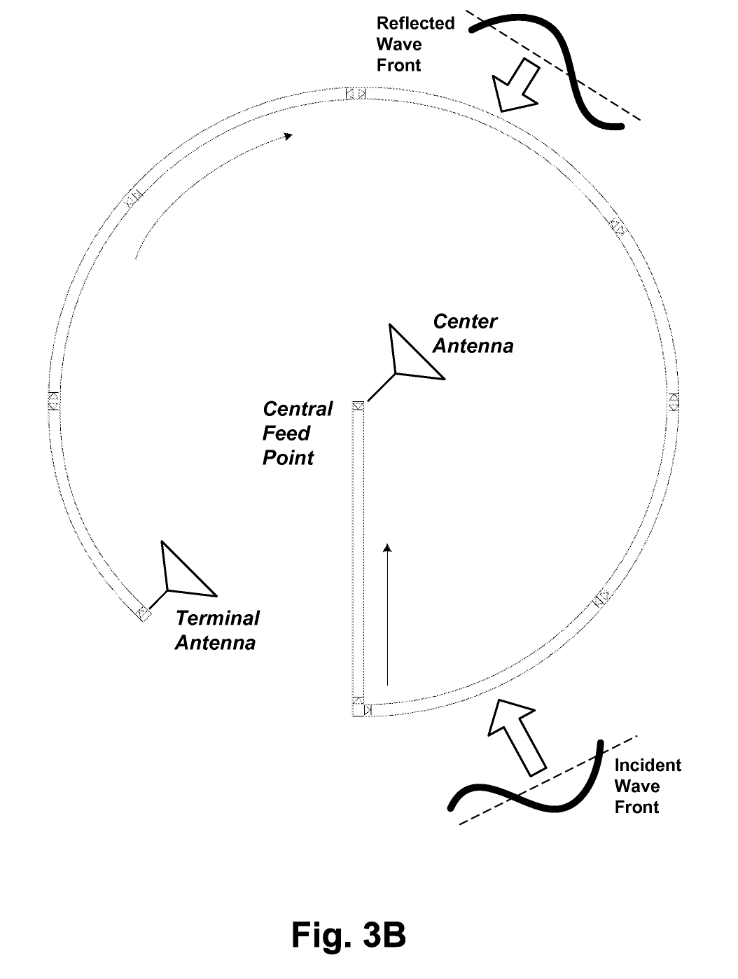

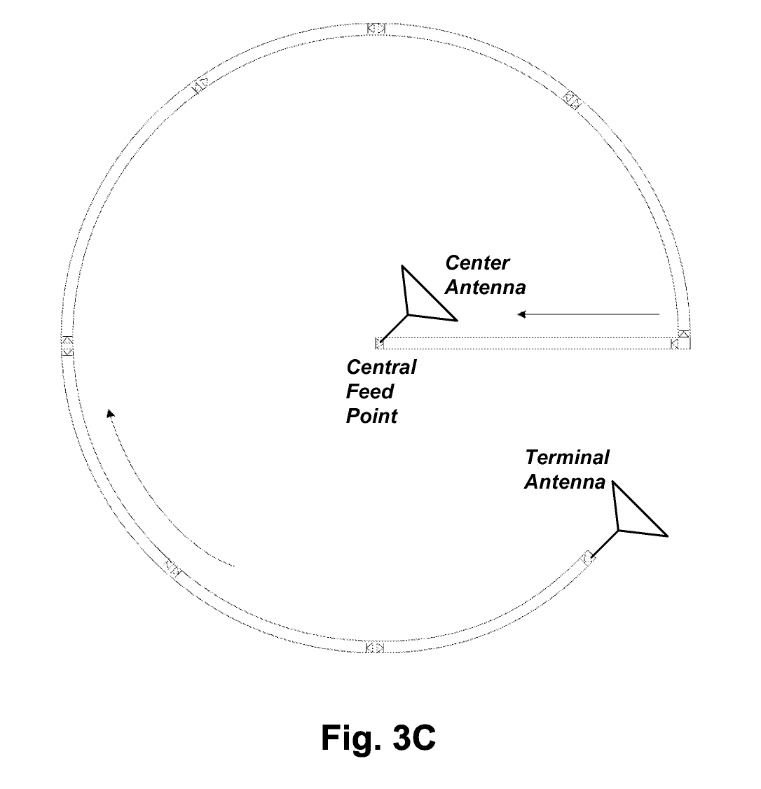

All antennas 210 are connected together and to the central feed point. However, this serial connection may comprise a different circular direction route, and feature connection to the center feed point via a different spoke element. Such different serial connections are illustrated in the FIGS. 3A-3C that are discussed detail below.

In the particular embodiment of FIG. 2, each RF section includes switching elements 212 and the phase shifter. The switching elements located at junctions between RF sections, allow for serial connection of the RF sections in a variety different spatial configurations relative to the central RF feed point.

In certain embodiments, the switching elements may comprise diodes. In particular embodiments, the switching elements may comprise PIN diodes.

It is noted that FIG. 2 illustrates only one particular example of an embodiment of a (circular) phased array antenna. The number of antenna counts can be reduced or increased based on the phase shift electrical length. For example for seven (7) antennas, the phase shift elements must be λ/6, where λ corresponds to the wavelength of the incident wireless signal. For five (5) antennas, the phase shift elements must be λ/4.

FIG. 2A is an enlarged and simplified cross-sectional view of an RF section and a corresponding junction including a PIN diode according to an embodiment. FIG. 2A shows the antennas connected to the circular microstrip by coupling through the directional coupler 216.

Returning to FIG. 2, in operation the switching elements create open/short circuits at select locations. As a result, the antennas 210 are connected serially in different orders.

The center antenna 212 is coupled to the input 218 of the RF transceiver for sending and receiving signals. However because the antenna array is switchable, different antennas in different physical locations around the center antenna, may be configured as the terminal antenna.

The path from different terminal antennas to the center antenna, can be changed to optimize signal reception and throughput. Certain different terminal antennas and different paths that may be configured using the switches (e.g., PIN diodes) are shown in the various FIGS. 3A-3C.

These various spatial configurations may afford communication throughput at different speeds for signals (including reflected signals) that are incoming from different directions. For example, in the highly simplified view presented in FIG. 3A, the array antenna spatial configuration may offer less gain, owing to absence of a serially-connected element being present in a spatial location optimal to receive a reflected signal.

By contrast, FIG. 3B shows an alternative spatial configuration in which the element 300 of the array antenna is positioned in space to receive the reflected signal with a highest gain, thereby contributing to the gain of the overall signal. It is noted this example is simplified for purposes of illustration, and in reality the relationship between output gain and array antenna spatial configuration is more complex than depicted here.

FIG. 3C shows yet another spatial configuration achievable by the array antenna according to the embodiment of FIG. 2. Depending upon the particular circumstances, the gain of the output signal resulting from the spatial orientation offered in FIG. 3C, may be better or worse than that of FIGS. 3A-3B. It should be apparent that many other spatial configurations are possible, depending upon operation of the switching elements of the array antenna.

FIG. 2B shows a simplified flow diagram of a method 250 according to an embodiment. A first step 252 comprises providing a plurality of electrically conducting sections in selective communication with one another and with a central feed point, via a plurality of switching elements. A second step 254 comprises coupling an antenna to each of the electrically conducting sections.

A third step 256 comprises controlling the plurality of switching elements to connect in series, N number of sections between a terminal antenna and a center antenna located at the central feed point. Each section has a length of λ/(N−1), where λ is a wavelength of an incoming wireless signal that is sought to be detected. As a result of this serial connection, a terminal antenna is defined.

A fourth step 258 comprises receiving at the central feed point, an output voltage corresponding to the wireless signal.

While FIG. 2 shows a particular wheel/spoke arrangement allowing serial connection of eight (8) sections of length (λ/8), others embodiments are possible. For example, alternative embodiments could comprise RF sections of a different number. Such RF sections could be arranged in a circle, square, rectangle, octagon, other polygons, or practically any geometric shape. Depending upon the constraints imposed by geometry, the individual RF sections could be other than a straight line, for example arranged in a non-linear manner about a central feed point.

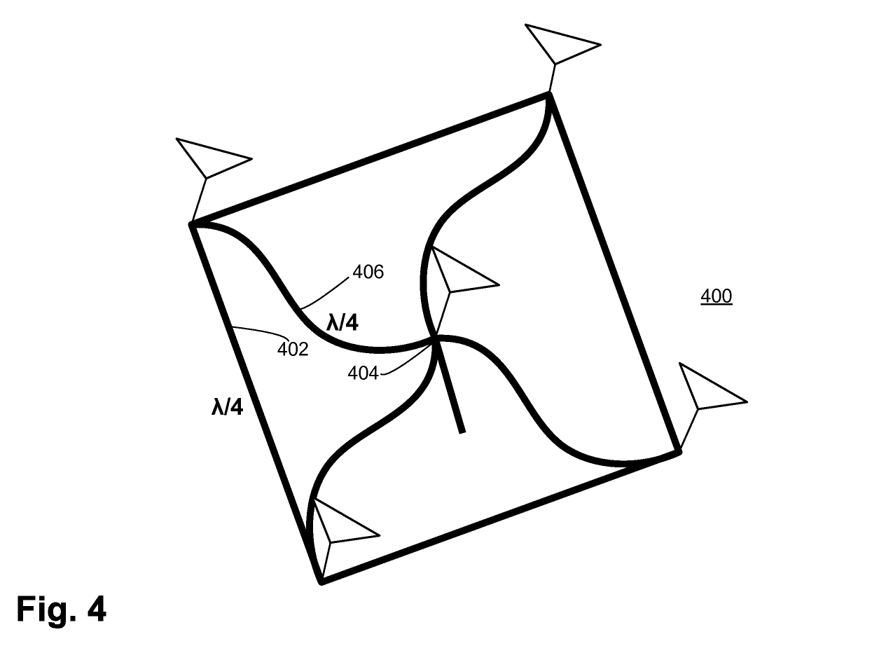

As one possible example of an array antenna having an alternative shape, FIG. 4 shows an array 400 including straight sections 402 having a length λ/4, arranged in the form of a square about a central feed point 404.

The central feed point is in turn in communication with these straight segments via one of the internal segments 406, which may be selected via a PIN diode or other switching element. These internal segments have a meandering shape that allows their overall length (λ/4) to match that of the external segments.

As mentioned above, the actual gain of the overall voltage output resulting from the spatial orientation of an array antenna, is actually the complex result of the combined signals received at each of the individual elements of the array. Moreover, this combined signal incorporates phase differences between the signals received at the individual elements of the array, from both the original incoming and reflected wireless signals. Hence, it can be difficult to determine an optimal spatial configuration for the array antenna in advance.

Accordingly, also described herein is a procedure for selecting a particular spatial configuration of an array antenna according to an embodiment. In particular, such a procedure may involve iterating through a plurality of possible serial connections between a central feed point and a terminal antenna, and sensing a communication throughput for each corresponding spatial configuration.

In certain embodiments this sensed communication throughput may be measured in terms of Packet Error Rate (PER). In other embodiments the sensed throughput may be measured in terms of Received Signal Strength Indicator (RSSI).

The procedure may be optimized for a particular client and signal, based upon sensed communication throughput. Thus one particular array antenna may be separately optimized to operate in different modes that receive incoming wireless signals from different directions from different clients.

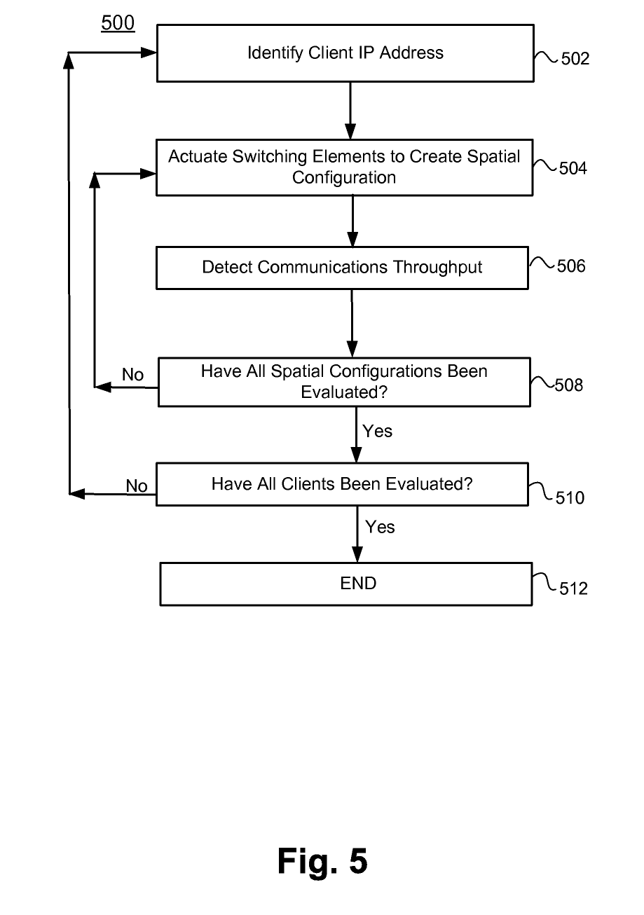

FIG. 5 is a simplified flow diagram showing the steps of a procedure 500 according to an embodiment. In a first step 502 comprises identifying an incoming wireless signal sent from particular client (e.g., utilizing the IP address).

In a second step 504, switching elements are actuated to cause the array antenna to assume a particular spatial configuration. In a third step 506, a communications throughput of the wireless signal is detected. As mentioned above, this metric may be quantified in terms of PER or RSSI.

In the next step 508, it is determined whether all possible spatial configurations have been tested. If not, then the procedure returns to step 504 to cause the array antenna to assume a different spatial configuration.

If all configurations have been tested, then in step 510 the procedure determines whether the wireless signals from all known clients have been evaluated. If not, the procedure returns to step 502 to detect a signal from another client.

Once it is determined that wireless signals from all clients have been evaluated, then the procedure ends in step 512.

While FIG. 5 indicates that the procedure iterates through the various antenna array spatial configurations for each client before moving on to detect a signal strength from other clients, this is not required. Procedures according to alternative embodiments could iterate through multiple different clients using the same antenna array spatial configuration, before moving on to evaluate signal strength for those clients in a next spatial configuration.

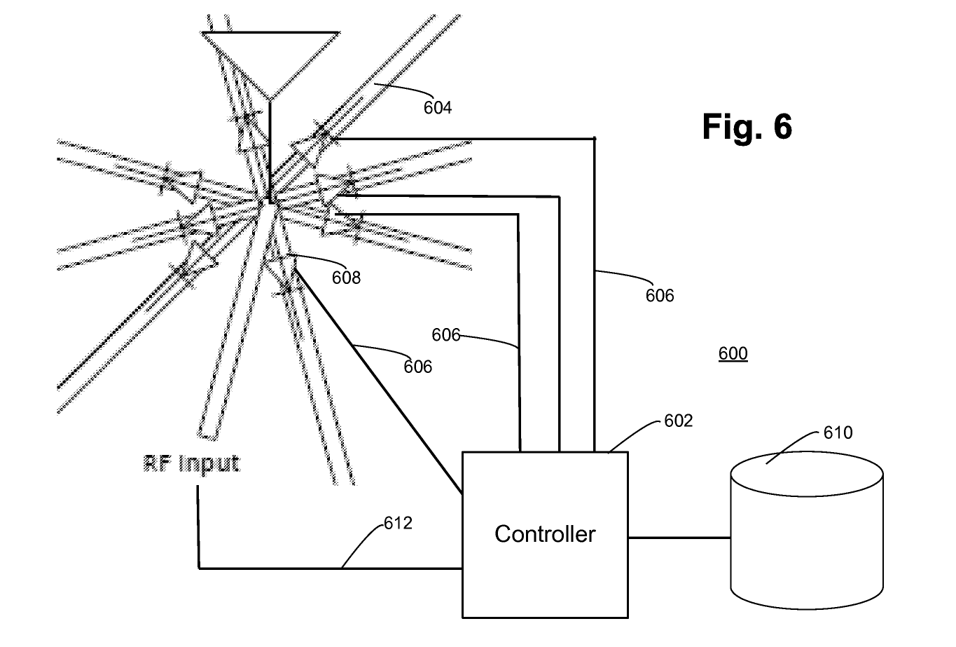

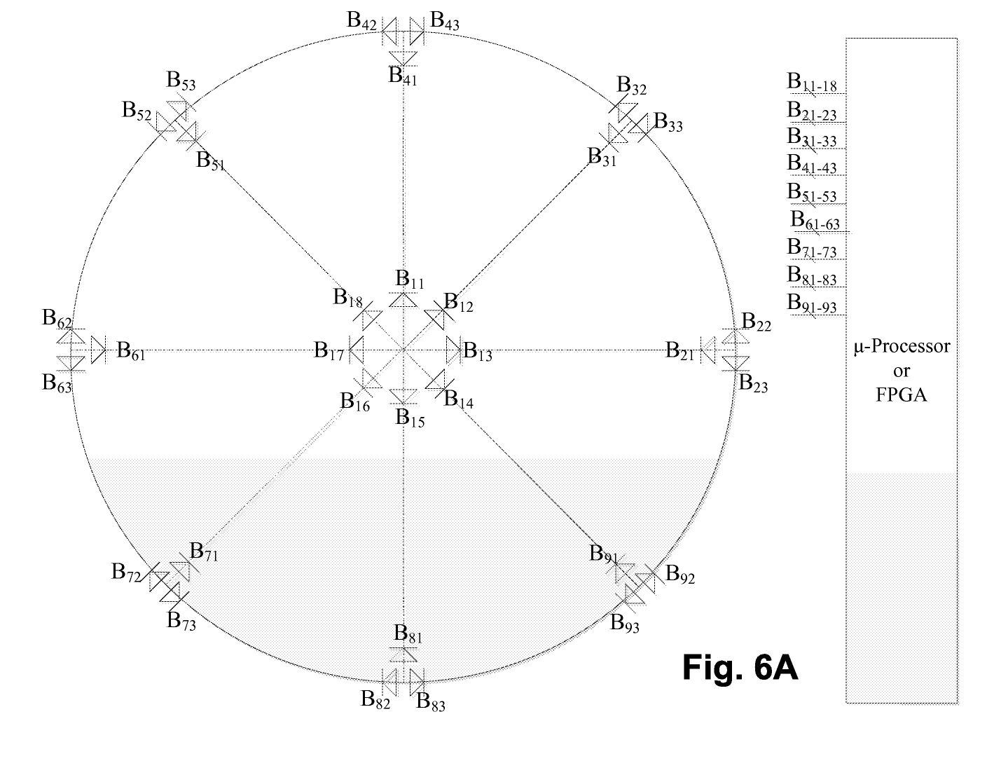

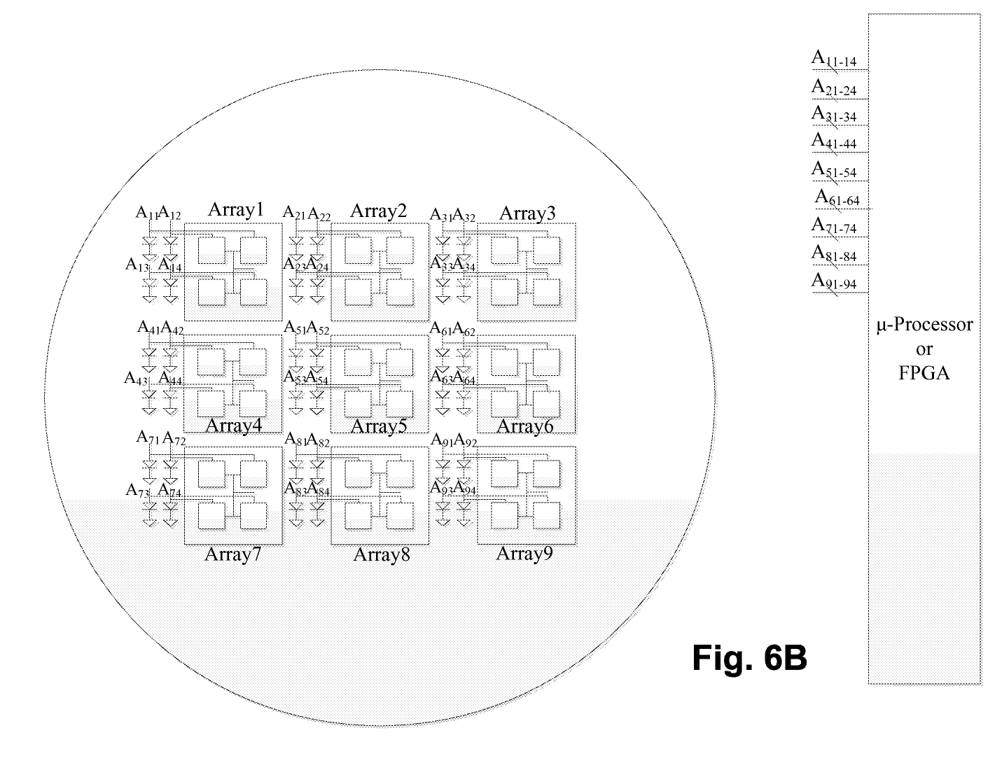

The procedures described above may be carried out utilizing a processor in communication with the array antenna. In particular, FIG. 6 shows a simplified view of a system 600 comprising controller 602 in communication with the array antenna 604. Such controllers can comprise microcontrollers, a microprocessors, or FPGAs, and control may be through a firmware.

In particular, conducting leads 606 connect various nodes of the controller to the various PIN diode switching elements 608. For purposes of clarity, leads to only some of the switching elements of the array antenna are shown in FIG. 6. FIGS. 6A-B show details of the connections of FIG. 6. Voltages applied to the PIN diodes by the controller are determined by instructions stored in non-transitory computer readable storage medium 610.

The controller is also in communication with the central feed point of the antenna array via lead 612. In this manner the controller can determine the signal throughput (e.g., PER, RSSI) of any given spatial configuration resulting from application of voltages to the various switching elements by the controller.

FIGS. 6A and 6B show embodiments of the nine arrays of antennas in circular configuration. Each antenna comprises elements. The routes are digitally controlled through the μ-processor or field programmable gate array (FPGA).

FIG. 6A shows that there are three PIN diodes per antenna feeders to select the direction, and the central antenna comprises eight PIN diodes to choose the desired route. One PIN diode will be connected (short circuit) at a time, and seven others will be disconnected (open circuit).

FIG. 6B shows that each antenna element can also be controlled in combination of the routing.

The above description illustrates various embodiments of the present disclosure along with examples of how aspects of the particular embodiments may be implemented. The above examples should not be deemed to be the only embodiments, and are presented to illustrate the flexibility and advantages of the particular embodiments as defined by the following claims. Based on the above disclosure and the following claims, other arrangements, embodiments, implementations and equivalents may be employed without departing from the scope of the present disclosure as defined by the claims.

What is claimed is:

1. An antenna comprising:
a center antenna located at a central feed point;
conducting sections of equal length disposed around the central feed point, each conducting section coupled to a respective antenna;
switching elements disposed between the conducting sections; and
a controller in communication with the switching elements to serially connect the conducting sections in spatial configurations having different terminal antennas, the controller in communication with the central feed point to determine a signal communication throughput for each spatial configuration.

2. The antenna of claim 1 wherein the switching elements comprise diodes.

3. The antenna of claim 2 wherein the diodes comprise PIN diodes.

4. The antenna of claim 1 wherein the conducting sections comprise:
a connecting section in communication with the central feed point; and
a peripheral section in communication with the connecting section.

5. The antenna of claim 4 wherein the connecting section defines a spoke and the peripheral section defines a part of a wheel.

6. The antenna of claim 4 wherein the peripheral section defines a part of a polygon.

7. The antenna of claim 4 wherein the peripheral section has a non-linear shape.

8. The antenna of claim 1 wherein the conducting sections comprise strips on a printed circuit board (PCB).

9. The antenna of claim 1 wherein the controller is configured to determine the signal communication throughput as a Packet Error Rate (PER).

10. The antenna of claim 1 wherein the controller is configured to determine the signal communication throughput as a Received Signal Strength Indicator (RSSI).

11. A method comprising:
controlling switching elements to define serially connected conducting sections of equal length and associated coupled antennas, in a first spatial configuration between a central feed point and a first terminal antenna;
determining a first signal communication throughput of the first spatial configuration;
controlling the switching elements to define serially connected conducting sections and associated coupled antennas, in a second spatial configuration between the central feed point and a second terminal antenna; and
determining a second signal communication throughput of the second spatial configuration.

12. The method of claim 10 wherein controlling the switching elements comprises applying voltage to a diode.

13. The method of claim 10 further comprising:
controlling the switching elements to iteratively define serially connected conducting sections and associated coupled antennas in remaining spatial configurations;
determining respective signal communication throughputs of the remaining spatial configurations; and
controlling the switching elements to define serially connected conducting sections and associated coupled antennas of a spatial configuration having a highest signal communication throughput.

14. The method of claim 10 wherein determining the first signal communication throughput comprises determining a Packet Error Rate (PER).

15. The method of claim 10 wherein determining the first signal communication throughput comprises determining a Received Signal Strength Indicator (RSSI).

16. The method of claim 10 wherein controlling the switching elements links a peripheral section with a connecting section in communication with the central feed point.

17. The method of claim 16 wherein peripheral section comprises part of a wheel and the connecting section comprises a spoke.

18. A method of optimizing gain of a series-fed array antenna, the method comprising:
controlling switching elements to serially connect conducting sections of equal length and associated coupled antennas, in different spatial configurations about a central feed point; and
determining a spatial configuration having a highest signal communication throughput.

19. The method of claim 18 wherein controlling the switching elements comprises applying voltage to a diode.

20. The method of claim 18 wherein the conducting sections comprise a wheel and spokes.
